(19) United States
(12) Patent Application Publication
(10) Pub. No.: US 2013/0140159 A1
(43) Pub. Date: Jun. 6, 2013

(54) PROCESS FOR PRODUCING A CU-CR MATERIAL BY POWDER METALLURGY

(71) Applicants: Claudia Kowanda, Oberageri (CH); Frank Müller, Adligenswil (CH)

(72) Inventors: Claudia Kowanda, Oberageri (CH); Frank Müller, Adligenswil (CH)

(73) Assignee: PLANSEE POWERTECH AG, SEON (CH)

(21) Appl. No.: 13/813,996

(22) PCT Filed: Aug. 1, 2011
(86) PCT No.: PCT/AT11/00319

§ 371 Date: Feb. 4, 2013

(30) Foreign Application Priority Data
Aug. 3, 2010 (AT) GM 484/2010

(51) Int. Cl. H01H 1/02; B22F 3/24

(52) U.S. Cl. CPC H01H 1/0206; B22F 3/24
USPC 200/265; 419/38; 419/29; 419/30; 75/245; 75/247

(57) ABSTRACT

A process for producing a Cu—Cr material by powder metallurgy for a switching contact, in particular for vacuum switches, includes the steps of pressing a Cu—Cr powder mixture formed from Cu powder and Cr powder and sintering the pressed Cu—Cr powder mixture to form the material of the Cu—Cr switching contact. The sintering or a subsequent thermal treatment process is carried out with an alternating temperature profile, in which the Cu—Cr powder mixture or the Cu—Cr material is heated above an upper temperature limit value and cooled again below a lower temperature limit value at least twice in alternation. All of the steps are carried out at temperatures at which no molten phase forms.

The present invention relates to a process for producing a Cu—Cr material by powder metallurgy for a switching contact, in particular for vacuum switches, and to a Cu—Cr switching contact produced by powder metallurgy, in particular for vacuum switches. It is concerned with producing a high-performance Cu—Cr material.

It is known to use Cu—Cr materials for switching contacts, in particular in the application area of the vacuum switching principle. The vacuum switching principle has already become established worldwide as a leading switching principle in the area of medium voltage, i.e. in the range from about 7.2 kV to 40 kV, and there is also an evident trend toward use at higher voltages. Such switching contacts are used for example both for medium-voltage vacuum circuit breakers and for vacuum contactors.

Among the requirements for the switching contacts are a high switching capacity that remains as constant as possible throughout the lifetime of the contact, a high dielectric strength and minimal erosion. It is endeavored to achieve a high erosion resistance, a good electrical and thermal conductivity, a minimal tendency for welding to occur during the switching operation as well as a high dielectric strength and adequate mechanical resistance of the switching contact.

DE 10 2006 021 772 A1 describes a process for producing copper-chromium contacts for vacuum switches. Copper-chromium contacts for vacuum switches are thereby produced by using a casting or spraying process with subsequent rapid quenching to create a thin copper-chromium sheet as a starting material for the contacts. Concentration profiles are thereby established in a direction perpendicular to the direction of the strip. A phase diagram of the Cu—Cr system is also presented and described.

As can be seen from the phase diagram, in the solid phase there is virtually no miscibility between Cu and Cr. Only in a small region below the eutectic that is found at a temperature of about 1075° C. is there a region in which there is a slight solubility of Cr in solid solution in Cu. The maximum solubility of Cr in Cu in solid solution in thermodynamic equilibrium, with about 0.7 at. %, is at 1075° C. At lower temperatures, the solubility of Cr in Cu falls and, at 400 ° C., there is only 0.03 at. % Cr in Cu in solid solution in thermodynamic equilibrium. A more detailed phase diagram of the Cu—Cr system is presented for example on page 524 of the manual by M. Hansen and K. Anderko “Constitution of Binary Alloys”, McGraw-Rill Book Company, Inc. (1958).

It follows from the phase diagram that, in the case of Cu—Cr materials with a typical content of 30-80% by weight Cu and 70-20% by weight Cr, at temperatures below the eutectic there are Cr grains in a Cu matrix. On account of the slight solubility of Cr in Cu in this region, there may be a small proportion of Cr in solid solution in the Cu matrix. Hereafter, the term Cu matrix is used even when there is a small proportion of Cr in solid solution in the Cu.

For producing Cu—Cr materials for switching contacts for vacuum switching technology, purely powder-metallurgical processes, sintering-impregnating processes and also melt-metallurgical processes are known.

On account of the complex phase diagram of the Cu—Cr system, the direct production of homogeneous melt materials is not possible. For this reason, materials known as remelt materials are often used for high-grade Cu—Cr materials for switching contacts for vacuum switches, it being possible for example for remelting using a laser or an arc to be employed.

Compared with melt-metallurgical production, purely powder-metallurgical production of Cu—Cr materials proves to be much more cost-effective for switching contacts for vacuum switches (hereafter also referred to as vacuum switching contacts). However, it has been found that the Cu—Cr materials produced by powder metallurgy have so far not yet had the desired properties to a satisfactory extent.

It is the object of the present invention to provide a process for producing a Cu—Cr material by powder metallurgy for a switching contact and to provide a Cu—Cr switching contact produced by powder metallurgy that not only provide a high erosion resistance, a good electrical and thermal conductivity, a minimal tendency for welding to occur during the switching operation as well as a high dielectric strength and adequate mechanical resistance of the switching contact but also make cost-effective production possible.

The object is achieved by a process for producing a Cu—Cr material by powder metallurgy for a switching contact as claimed in claim 1. Advantageous developments are specified in the dependent claims.

The process for producing a Cu—Cr material by powder metallurgy for a switching contact, in particular for vacuum switches, has the following steps: pressing a Cu—Cr powder mixture formed from Cu powder and Cr powder, sintering the pressed Cu—Cr powder mixture to form the material of the Cu—Cr switching contact. The sintering and/or a subsequent thermal treatment process is carried out with an alternating temperature profile, in which the Cu—Cr powder mixture or the Cu—Cr material is heated above an upper temperature limit value and cooled again below a lower temperature limit value at least twice in alternation. All of the steps are carried out at temperatures at which no molten phase forms. The entire process for producing the Cu—Cr material is consequently carried out purely powder-metallurgically at temperatures that lie below the temperature of the eutectic (1075° C.) of the Cu—Cr system, so that no molten phase forms. The term “purely powder-metallurgically” refers here to a process in which there is no formation of a molten phase. Either the sintering or subsequent thermal treatment process (or both) is/are carried out with an alternating temperature profile. An alternating temperature profile is understood here as meaning that a temperature increase and a temperature decrease take place in alternation, a temperature increase and a temperature decrease each taking place at least twice. With preference, the temperature increase and the temperature decrease take place at least three times. The alternating temperature profile may in this case already be executed for example during the sintering of the pressed Cu—Cr preform. However, it is also possible for example to expose the already (conventionally) sintered Cu—Cr material to the alternating temperature profile in a subsequent thermal treatment process. The upper temperature limit value may in this case be preferably chosen such that there is the greatest possible solubility of Cr in Cu in solid solution. The lower temperature limit value may preferably be chosen such that there is a much lower solubility of Cr in Cu in solid solution than at the upper temperature limit value.

The production of the Cu—Cr material may in this case be performed for example by the finished switching contact already being provided in its final form, or for example such that the switching contact is only given its final form by a suitable finishing operation.

The purely powder-metallurgical production allows the Cu—Cr material to be provided in a particularly cost-effective way. The alternating temperature profile (cyclic annealing) achieves the effect that many Cr grains with grain sizes with a cross section of between 0.1 μm² and 50 μm² (measured in the micrograph) are formed in a Cu matrix. The Cu—Cr material formed consequently has a grain size distribution of the Cr grains measured in the micrograph that has a first maximum in the region of grain sizes with a cross section of between 0.1 μm² and 50 μm². The determination of the grain size distribution is performed in this case microscopically in a micrograph by measuring the surface areas of the respective Cr grains. Microscopically is understood here as meaning by light microscopy and electron microscopy.

A Cu—Cr material for a switching contact that is produced in a very cost-effective way and thereby at the same time achieves a high erosion resistance, a good electrical and thermal conductivity, a minimal tendency for welding to occur during the switching operation as well as a high dielectric strength and adequate mechanical resistance of the switching contact is achieved in this way. By realizing the alternating temperature profile, the described advantageous grain size distribution is achieved without any problem even when relatively coarse Cr powder (for example with particle diameters of between 20 μm and 200 μm) is used as the starting material.

In the case of a purely powder-metallurgical production process without executing the alternating temperature profile, in which for example Cu powder and Cr powder with maximum particle diameters of up to approximately 200 μm are used, the resultant Cu—Cr material has a microstructure in which there are in the micrograph relatively large Cr grains with a grain diameter in the range between 100 μm and 150 μm along with some smaller Cr grains in a Cu matrix. This then typically yields a unimodal grain size distribution with a maximum for example at grain sizes in the range between 100 μm² and 25000 μm² . This implies that the particle sizes of the Cr powder as the starting material are substantially retained in the resultant Cu—Cr material unless the alternating temperature profile is executed.

On the other hand, use of much finer-grained Cr powder as the starting material would lead to further problems. The production process would be made much more difficult. Fine-grained Cr powders have a much higher oxygen content than coarse-grained powder. As a result, the binding of the Cr phase into the Cu matrix is made more difficult, which causes a higher porosity. It has also been found that the degree of impurities due to oxides in fine Cr powder fractions is higher than in coarse-grained powders. A further difficulty in the processing of fine powders is that of handling, in terms of avoiding the uptake of oxygen during the production process, and that of ensuring sufficient safety in the workplace. Furthermore, to achieve a satisfactory density and a low porosity of the material, a higher pressing pressure is required, or a cold working of the sintered material would be necessary. With the specified process steps, by contrast, the desired properties of the Cu—Cr material can be achieved in a cost-effective way using conventional production plants.

With the process for producing the Cu—Cr material, a low porosity, a high density, an extremely low degree of impurities, finely and homogeneously isotropically distributed Cr grains in a Cu matrix and a constant homogeneous chemical composition of the Cu—Cr material are achieved. The resultant Cu—Cr material is outstandingly suitable for switching contacts for use in vacuum switching technology, both as a circuit breaker in the high-voltage and medium-voltage area and as a vacuum contact in the low-voltage area.

According to a refinement, the upper temperature limit value lies in the range between 1065° C. and 1025° C. and the lower temperature limit value lies at least 50° C. below the upper temperature limit value. The lower temperature limit value preferably lies at least 100° C. below the upper temperature limit value. In this case, the upper temperature limit value lies in a temperature range just below the temperature of the eutectic (1075° C.), that is to say a range in which up to approximately 0.7 at. % Cr can be dissolved in the Cu matrix in solid solution. This corresponds to the range in which there is the maximum solubility of Cr in Cu in solid solution. On the other hand, the upper temperature limit value lies far enough below the temperature of the eutectic that the formation of a molten phase is reliably prevented even when there are slight temperature fluctuations. The lower temperature limit value lies well below the upper temperature limit value, that is to say in a range in which (in thermal equilibrium) a much smaller amount of Cr can be dissolved in the Cu matrix in solid solution. Consequently, when there is heating above the upper temperature limit value, Cr is enriched in the material of the Cu matrix (up to a maximum of about 0.7 at. %). When there is cooling below the lower temperature limit value (which corresponds to a vertical movement in the phase diagram), the amount of Cr dissolved in solid solution exceeds the solubility corresponding to this lower temperature value, which is much less than 0.7 at. %. Consequently, Cr is precipitated from the Cu matrix and Cr grains with small grain sizes form. If there is repeated execution of the alternating temperature profile, the number of Cr grains with small grain sizes that are formed initially increases.

According to a refinement, the process also has the following step: mixing Cu powder and Cr powder to form a Cu—Cr powder mixture. In this case, the Cu—Cr powder mixture can be provided in a simple way by using customary Cr powder and Cu powder.

According to a refinement, the Cu particles in the Cu—Cr powder mixture have a particle size distribution with a maximum particle diameter of ≦80 μm, preferably ≦50 μm. In this case, a reliable formation of the Cu matrix is made possible in the sintering process and the Cu—Cr material can be reliably provided with a low porosity and high density. The maximum particle diameter is in this case determined by means of a screen analysis. In this case, a screen with a corresponding mesh width (for example 80 μm or 50 μm) is used, and only particles that fall through the screen are used.

According to a refinement, the Cr particles in the Cu—Cr powder mixture have a particle size distribution with a maximum particle diameter of 200 μm, preferably 160 μm. The maximum particle diameter is in turn determined by a screen analysis with a corresponding mesh width of the screen. In this case, the value for the maximum particle diameter is small enough to achieve the result that there are no over-large Cr grains in the Cu—Cr material. On the other hand, the individual particles can also be formed large enough that there is no overt risk of impurities due to oxides occurring, and a high density and a low degree of porosity can be achieved in conventional production plants.

According to a refinement, the Cr particles in the Cu—Cr powder mixture have a particle size distribution with a minimum particle diameter of ≧20 μm, preferably ≧32 μm. The minimum particle diameter is in this case likewise determined by a screen analysis (with a mesh width of for example 20 μm or 32 μm), but in this case only the particles that do not fall through the screen are used. In this case, the minimum particle diameter is large enough that there is no overt risk of impurities due to oxides occurring, and a high density and a low degree of porosity can be achieved in conventional production plants.

According to a refinement, the Cu—Cr powder mixture has a Cu content of between 30% by weight and 80% by weight and a Cr content of between 70% by weight and 20% by weight. In this case it is achieved that not only a high erosion resistance and a low welding tendency but also good electrical and thermal conductivity and a sufficient mechanical strength can be provided. If the Cr content exceeds 70% by weight, this leads to a notable impairment of the thermal and electrical conductivity. If the Cr content is less than 20% by weight, a satisfactory erosion resistance and welding tendency cannot be achieved.

The object is also achieved by a Cu—Cr switching contact produced by powder metallurgy as claimed in claim 8. Advantageous developments are specified in the dependent claims. The Cu—Cr switching contact may be designed for vacuum switches.

The Cu—Cr switching contact produced by powder metallurgy has a Cu content of between 30% by weight and 80% by weight and a Cr content of between 70% by weight and 20% by weight. The Cu—Cr switching contact has Cr grains in a Cu matrix. A grain size distribution of the Cr grains, measured in the micrograph, has a first maximum in the range of grain sizes with a cross-sectional area of between 0.1 μm² and 50 μm². The switching contact is produced by a powder-metallurgical process from Cu powder and Cr powder without the formation of a molten phase. It consequently concerns a Cu—Cr switching contact produced purely by powder metallurgy.

A Cu matrix is understood here as meaning a material which primarily consists of Cu, but may also have a small proportion of Cr in solid solution. There may furthermore also be traces of impurities. Cr grains are formed in the Cu matrix. The grain size distribution of the Cr grains is in this case determined as follows: a micrograph of the Cu—Cr material of the switching contact is prepared and microscopically analyzed. In the micrograph, the Cr grains are identified and the cross-sectional areas of the Cr grains are measured. The evaluation is performed in this case over a sufficiently large surface area or various surface areas that form a sufficiently large overall surface area, so that a representative, statistical finding is made possible. The evaluation may be carried out for example manually or else with the aid of suitable software. In a graphic depiction with the measured cross-sectional area on the x axis and the associated number of determined Cr grains with the respective cross-sectional area per unit area (for example per mm²) on the y axis (preferably in each case in a logarithmic representation), the grain size distribution is evident. The grain size distribution has a maximum in a range of grain sizes with a measured cross-sectional area of between 0.1 μm² and 50 μm².

With the Cu—Cr switching contact produced by powder metallurgy, the advantages described above with reference to the process for producing a Cu—Cr material by powder metallurgy for a switching contact are achieved. The purely powder-metallurgical production makes particularly cost-effective production possible. On account of the grain size distribution with the maximum in the range of grain sizes with a cross-sectional area of between 0.1 μm² and 50 μm², the Cu—Cr switching contact has a great number of fine Cr grains. The fine Cr grains are in this case homogeneously distributed to the greatest extent. In this way, a very good erosion resistance is achieved. The Cu—Cr switching contact is obtainable by a purely powder-metallurgical process, in which sintering or a subsequent thermal treatment process is carried out with an alternating temperature profile, in which a Cu—Cr powder mixture or the material of the Cu—Cr switching contact is heated above an upper temperature limit value and cooled again below a lower temperature limit value at least twice in alternation and in which all of the steps are carried out at temperatures at which no molten phase forms. The production in a purely powder-metallurgical process is evident from the Cu—Cr switching contact.

According to a refinement, the grain size distribution of the Cr grains has a second maximum in the range of grain sizes with a cross-sectional area of between 100 μm² and 10000 μm². There is consequently a bimodal Cr phase distribution that has two maximums, a first maximum for grain sizes with a measured cross-sectional area of between 0.1 μm² and 50 μm² and a second maximum for grain sizes with a measured cross-sectional area of between 100 μm² and 10000 μm². This grain size distribution results from the purely powder-metallurgical production process using coarse Cr powder, for example with particle diameters of between 20 μm and 200 μm.

According to a refinement, the number of Cr grains corresponding to the first maximum is greater than the number of Cr grains corresponding to the second maximum, i.e. there are more grains that have a grain size corresponding to the first maximum than grains that have a grain size corresponding to the second maximum. In this case, there are many fine Cr grains with cross-sectional areas of between 0.1 μm² and 50 μm² in relation to the total number of Cr grains. A particularly advantageous erosion resistance is achieved. If the number of Cr grains corresponding to the first maximum is greater than the number of Cr grains corresponding to the second maximum by a factor of >5, there is a particularly advantageous proportion of fine Cr grains with a small cross-sectional area.

According to a refinement, the Cu—Cr switching contact has a relative density of >90%. In this case, a good electrical and thermal conductivity and a high mechanical strength are reliably provided. Such a high relative density can be reliably achieved in conventional production plants if relatively coarse Cr powder and Cu powder are used. Relative density is understood here as meaning the ratio between the density achieved and the theoretically achievable density for the composition. The combination of this high density and the high proportion of fine Cr grains in the Cu matrix can be achieved by the combination of using coarse Cr powder (with particle diameters of between 20 μm and 200 μm) and using an alternating temperature profile in which heating above an upper temperature limit value and cooling again below a lower temperature limit value are performed at least twice in alternation.

Further advantages and developments emerge from the following description of an embodiment with reference to the figures.

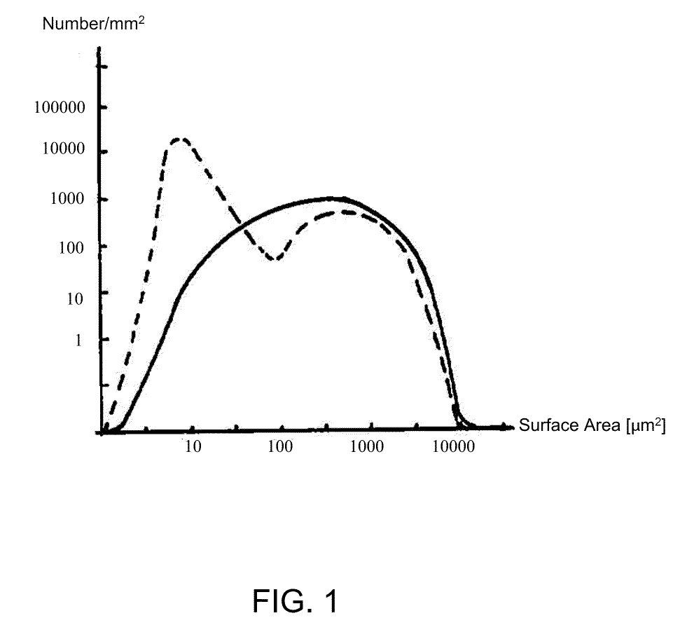

FIG. 1 shows a grain size distribution of the Cr grains in the case of a Cu—Cr material produced by powder metallurgy in the starting state (solid line) and after executing an alternating temperature profile (dashed line).

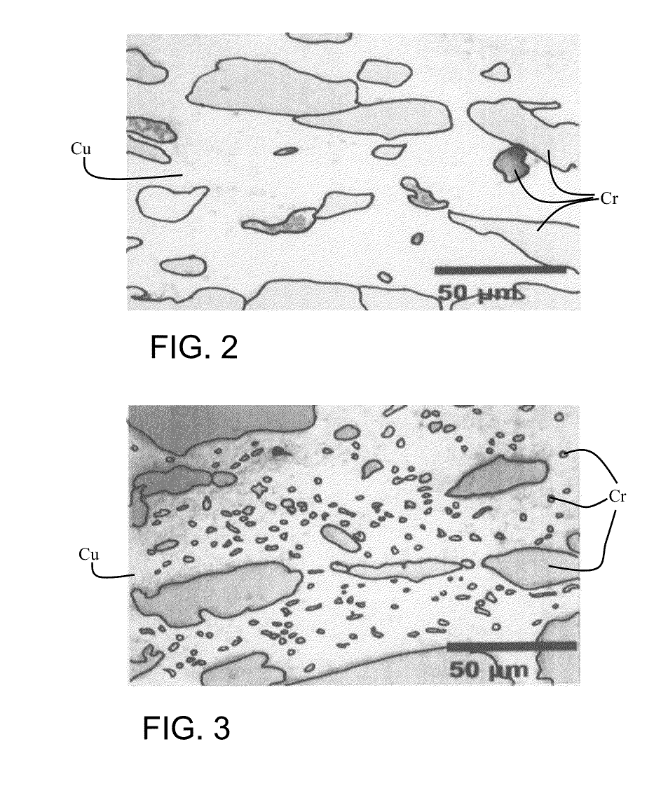

FIG. 2 shows a light-microscope micrograph of a Cu—Cr material produced by powder metallurgy.

FIG. 3 shows an light-microscope micrograph of a Cu—Cr material produced by powder metallurgy after executing an alternating temperature profile.

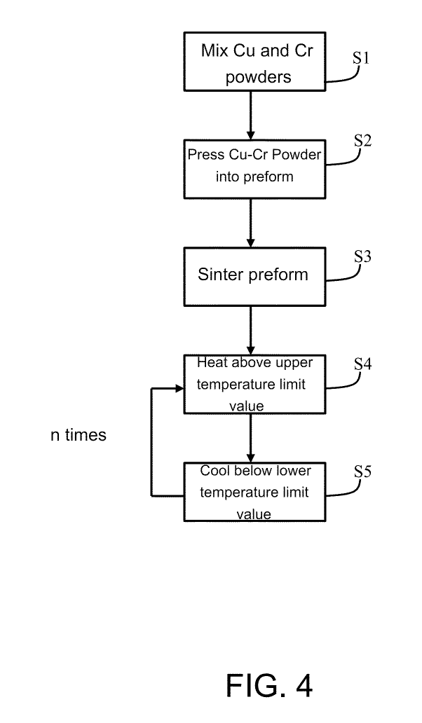

FIG. 4 schematically shows the process steps of a process for producing a Cu—Cr material by powder metallurgy for a switching contact.

A process for producing a Cu—Cr material by powder metallurgy for a switching contact for vacuum switches according to a first embodiment is described below with reference to FIGS. 1 to 4.

In a first step—S1—Cu powder with a maximum particle diameter of preferably at most 50 μm is mixed with Cr powder with a maximum particle diameter of at most 200 μm (preferably at most 160 μm) and a minimum particle diameter of at least 20 μm (preferably at least 32 μm) to form a Cu—Cr powder mixture. For example, a first Cu—Cr powder mixture with a Cr content of 25% by weight and a Cu content of 75% by weight and a second Cu—Cr powder mixture with a Cr content of 43% by weight and a Cu content of 57% by weight were created as examples.

In a second step—S2—the Cu—Cr powder mixture is pressed. With preference, the Cu—Cr powder mixture is compacted by cold pressing with a pressing pressure in a range between 400 MPa and 850 MPa. In a subsequent step—S3—the preform formed in this way is sintered in a sintering process at temperatures in a temperature range well below the temperature of the eutectic (therefore well below 1075° C.) Consequently, a molten phase does not form in the Cu—Cr powder mixture or in the pressed preform in any of the steps—S1—to—S3—. The sintering process may, for example, be carried out at temperatures in a temperature range between 850° C. and 1070° C. The temperatures must in this case be high enough that the sintering process proceeds to a sufficient extent and with sufficient speed, and low enough that no molten phase forms even in the event of unavoidable temperature gradients.

A light-microscope micrograph of a Cu—Cr material produced by powder metallurgy after step—S3—is presented in FIG. 2 by way of example. In FIG. 2 it can be seen that Cr grains with different grain sizes are bound in a Cu matrix. A closer analysis of the grain distribution in the case of the examples mentioned showed that the grain sizes of the Cr grains corresponded substantially to the particle sizes of the Cr powder of the starting material.

An evaluation of the grain size distribution of the Cr grains in the Cu—Cr material produced in such a way is represented in FIG. 1 by a solid line. A micrograph of the Cu—Cr material was prepared and the size of the Cr grains was microscopically examined and measured. In this case, 10 different regions of the Cu—Cr material were analyzed, in order to obtain a statistically meaningful distribution. In FIG. 1, the measured cross-sectional area of the Cr grains in μm² is plotted on the horizontal axis in a logarithmic scale. The corresponding number of grains normalized to a unit area of 1 mm² is shown on the vertical axis, likewise in a logarithmic representation. As can be seen in FIG. 1, the Cu—Cr material has in this stage of the process a monomodal grain size distribution with grain sizes in a range between approximately 10 μm² and 25000 μm². The grain size distributional has in this case a maximum that is for grain sizes in a range greater than 100 μm².

The Cu—Cr material is subsequently subjected to a thermal treatment process with an alternating temperature profile, as described below. The Cu—Cr material is thereby alternately heated to a temperature above an upper temperature limit value and cooled to a temperature below a lower temperature limit value. In this case, the alternating heating and cooling are performed at least twice. It is also ensured in these process steps that no molten phase forms, i.e. the Cu—Cr material is kept at temperatures below the temperature of the eutectic (1075° C.) of the Cu—Cr system. This is described in further detail below.

In a step—S4—the Cu—Cr material is heated to a temperature above the upper temperature limit value. The upper temperature limit value in this case preferably lies relatively close below the temperature of the eutectic of the Cu—Cr system, so that the Cu—Cr material is brought to a temperature just below the temperature of the eutectic, but is far enough from the temperature of the eutectic that formation of a liquid phase is reliably prevented. The upper temperature limit value consequently preferably lies in a range between 1025° C. and 1065° C.

Subsequently, in a step—S5—the Cu—Cr material is cooled to a temperature below a lower temperature limit value. The lower temperature limit value in this case preferably lies in a range that is at least 50° C. below the upper temperature limit value, more preferably in a range over 100° C. below the upper temperature limit value. The lower temperature limit value in this case preferably lies at most 250° C. below the upper temperature limit value, more preferably at most 180° C. below the upper temperature limit value. The lower temperature limit value should be chosen such that at this value there is a much lower solubility of Cr in solid solution in Cu than at the upper temperature limit value. The reason for this choice will be explained in more detail. For example, the Cu—Cr material may be cooled to temperatures in the range of about 850° C. It is recommendable not to choose the lower temperature limit value too low, in order to ensure an adequate degree of diffusion processes in the Cu—Cr material. The Cu—Cr material is kept at the upper temperature limit value and the lower temperature limit value for some time in each case.

Subsequently, step—S4—is repeated, i.e. the Cu—Cr material is raised again to a temperature above the upper temperature limit value. After that, step—S5—is repeated, i.e. the Cu—Cr material is cooled again to a temperature below the lower temperature limit value. Steps—S4—and—S5—are repeated altogether n times, but in total at least twice, preferably at least three times. It has been found that, if steps—S4—and—S5—are executed from 2 to 6 times (2≦n≦6), an improvement in the Cu—Cr material is achieved and no further improvement can be expected from a greater number of repetitions. The Cu—Cr material is therefore subjected to a cyclic annealing. At least steps—S4—and—S5—are carried out in a protective-atmosphere furnace under a reducing atmosphere and/or in a vacuum furnace, in order to avoid undesired oxidation. The production process is subsequently ended.

FIG. 3 shows a light-microscope micrograph of a Cu—Cr material produced by powder metallurgy after executing the alternating temperature profile described.

In FIG. 3 it can be seen that, after carrying out the cyclic annealing, the proportion of Cr grains with a small cross-sectional area has increased significantly in comparison with the state before the cyclic annealing (cf. FIG. 2). A closer analysis of the grain size of the Cr grains shows that a bimodal grain size distribution that has two maximums has been established.

In FIG. 1, the determined grain size distribution after executing the alternating temperature profile is represented as a dashed line. The grain size distribution was determined in the same way as already described above with reference to the solid line of FIG. 1. It is evident that, after the cyclic annealing, there is a bimodal grain size distribution instead of the previous monomodal grain size distribution (solid line). The grain size distribution has a first maximum in a range of grain sizes with a cross-sectional area of between 0.1 μm² and 50 μm². Furthermore, the grain size distribution has a second maximum in the range of grain sizes with a cross-sectional area of between 100 μm² and 10000 μm². The number of Cr grains corresponding to the first maximum is greater than the number of Cr grains corresponding to the second maximum. The number of Cr grains corresponding to the first maximum is greater than the number of Cr grains corresponding to the second maximum by a factor of >5. There is furthermore a very homogeneous distribution of the Cr grains in the Cu matrix. The proportion of Cr grains with a cross-sectional area of <10 μm², measured in the micrograph, is consequently very high. Consequently, the thermal treatment with the alternating temperature profile has the effect of achieving a shift to a high proportion of very small finely distributed Cr grain precipitates in the Cu matrix.

With the starting materials described, having a relatively coarse particle size of the Cr powder, very dense Cu—Cr materials with low porosity that also have a very low degree of impurities can be produced in a purely powder-metallurgical process by conventional production plants. The purely powder-metallurgical production is evident from the Cu—Cr material. On account of the very finely distributed Cr grains, the Cu—Cr material produced purely by powder metallurgy has a high erosion resistance, a high dielectric strength and a sufficient mechanical strength of the switching contact.

The formation of the finely distributed Cr grains in the Cu matrix can be explained as follows with regard to the phase diagram that is represented for example in DE 10 2006 021 772 A1, mentioned at the beginning: at temperatures above the upper temperature limit value in a region just below the temperature of the eutectic, up to approximately 0.7 at. % Cr in solid solution can be dissolved in the material of the Cu matrix (in thermodynamic equilibrium). When there is cooling of the Cu—Cr matrix to a temperature below the lower temperature limit value, the material is brought to a temperature at which only a much smaller proportion of Cr in solid solution can be dissolved in the material of the Cu matrix in thermodynamic equilibrium. Consequently, during the cooling Cr is precipitated from the material of the Cu matrix and this precipitation takes place in the form of small grains. With renewed heating, taking the temperature above the upper temperature limit value, Cr in solid solution enters the material of the Cu matrix again. With renewed lowering of the temperature below the lower temperature limit value, Cr is precipitated again on account of the lower solubility in solid solution, which leads to fine Cr grains. In this way, the described bimodal grain size distribution of the Cr grains forms.

It has been found that, for a satisfactory formation of fine Cr grains, the temperature should go above the upper temperature limit value and below the lower temperature limit value at least twice. However, as from a certain number of repetitions of the cyclic annealing, no improvement in the structure can be observed any longer. The change in temperature between the high temperature level and the low temperature level in the cyclic annealing should be chosen to be sufficiently slow that Cr is reliably precipitated from the Cu matrix during the cooling, but on the other hand not too slow, in order that larger Cr grains do not occur again due to grain coarsening.

Experiments with Cu—Cr powder mixtures with other ratios of Cr and Cu were also carried out and likewise led to comparable results. Experiments with a Cr content of 70% by weight and a Cu content of 30% by weight also led to a comparable result with respect to the fine Cr precipitates.

Although it has been described that the treatment with the alternating temperature profile is not performed on the Cu—Cr material until after step—S3—of sintering, it is also possible for example already to carry out the sintering process itself with an alternating temperature profile. In this case, the pressed Cu—Cr preform is already subjected repeatedly to steps—S4—and—S5—during the sintering operation. In this case, the separate step—S3—is omitted and the sintering is performed during steps—S4—and—S5—.

1-12. (canceled)

13. A process for producing a Cu—Cr material by powder metallurgy for a switching contact or a vacuum switch contact, the process comprising the following steps:
pressing a Cu—Cr powder mixture formed from Cu powder and Cr powder;
sintering the pressed Cu—Cr powder mixture to form the material of the Cu—Cr switching contact; and
carrying out at least one of a sintering or subsequent thermal treatment process with an alternating temperature profile by heating the Cu—Cr powder mixture or the Cu—Cr material above an upper temperature limit value and cooling the Cu—Cr powder mixture or the Cu—Cr material again below a lower temperature limit value at least twice in alternation, and carrying out all of the steps at temperatures at which no molten phase forms.

14. The process according to claim 13, which further comprises setting the upper temperature limit value in a range between 1065° C. and 1025° C. and setting the lower temperature limit value at least 50° C. below the upper temperature limit value or at least 100° C. below the upper temperature limit value.

15. The process according to claim 13, which further comprises additionally performing a step of mixing Cu powder and Cr powder to form the Cu—Cr powder mixture.

16. The process according to claim 13, which further comprises providing Cu particles in the Cu—Cr powder mixture having a particle size distribution with a maximum particle diameter of 80 μm or 50 μm.

17. The process according to claim 13, which further comprises providing Cr particles in the Cu—Cr powder mixture having a particle size distribution with a maximum particle diameter of 200 μm or 160 μm.

18. The process according to claim 13, which further comprises providing Cr particles in the Cu—Cr particle mixture having a particle size distribution with a minimum particle diameter of 20 μm or 32 μm.

19. The process according to claim 13, which further comprises providing the Cu—Cr powder mixture with a Cu content of between 30% by weight and 80% by weight and a Cr content of between 70% by weight and 20% by weight.

20. A Cu—Cr switching contact produced by powder metallurgy, the switching contact comprising:
a Cu content of between 30% by weight and 80% by weight;
a Cr content of between 70% by weight and 20% by weight;
Cr grains in a Cu matrix having a grain size distribution of the Cr grains, measured in a micrograph, with a first maximum in a range of grain sizes having a cross-sectional area of between 0.1 μm² and 50 μm²; and
Cu powder and Cr powder formed into the switching contact by powder-metallurgy without a formation a molten phase.

21. The Cu—Cr switching contact produced by powder metallurgy according to claim 20, wherein the switching contact is a vacuum switching contact.

22. The Cu—Cr switching contact produced by powder metallurgy according to claim 20, wherein said grain size distribution of said Cr grains has a second maximum in a range of grain sizes with a cross-sectional area of between 100 μm² and 10,000 μm².

23. The Cu—Cr switching contact produced by powder metallurgy according to claim 22, wherein a number of Cr grains corresponding to said first maximum is greater than a number of Cr grains corresponding to said second maximum.

24. The Cu—Cr switching contact produced by powder metallurgy according to claim 22, wherein a number of Cr grains corresponding to said first maximum is greater than a number of Cr grains corresponding to said second maximum by a factor of >5.

25. The Cu—Cr switching contact produced by powder metallurgy according to claim 20, wherein the Cu—Cr switching contact has a relative density of >90%.
